(19) United States
(12) Patent Application Publication
(10) Pub. No.: US 2015/0333598 A1
(43) Pub. Date: Nov. 19, 2015

(54) VIBRATIONAL ENERGY HARVESTING FOR STRUCTURAL HEALTH INSTRUMENTATION

(71) Applicant: The Trustees of the Stevens Institute of Technology, Hoboken, NJ (US)

(72) Inventors: Mark M. Conticchio, North Caldwell, NJ (US); Joseph Gombar, Levittown, NY (US); Diana Jandreski, Jersey City, NJ (US); John Murphy, Morris Plains, NJ (US); Curtis Stecyk, Niwot, CO (US); Lisa Tessitore, Dobbs Ferry, NY (US); Leslie Brunell, Hoboken, NJ (US); Frank Fisher, Hoboken, NJ (US); Bruce McNair, Holmdel, NJ (US); Marcus Rutner, Hoboken, NJ (US)

(73) Assignee: The Trustees of the Stevens Institute of Technology, Hoboken, NJ (US)

(21) Appl. No.: 14/712,042

(22) Filed: May 14, 2015

Related U.S. Application Data
(60) Provisional application No. 61/993,473, filed on May 15, 2014.

(51) Int. Cl. H02K 7/18; G01P 15/08; H02P 9/00; G01L 1/00; F03G 7/08; H02K 35/00

(52) U.S. Cl. CPC H02K 7/1876; F03G 7/08; H02K 35/00; H02P 9/00; G01L 1/005; G01P 15/0802

(57) ABSTRACT

A system includes a vibrational energy harvesting device adapted to receive vibrational energy and convert the vibrational energy to electrical energy. The system also includes a computing device having an electrical connection to the vibrational energy harvesting device. The system also includes a sensor having an electrical connection and a data connection to the computing device. The system also includes a transmitter having an electrical connection and a data connection to the computing device. When the computing device receives the electrical energy from the vibrational energy harvesting device, the computing device is configured to receive sensor data from the sensor via the data connection between the computing device and the sensor and operate the transmitter to wirelessly transmit the sensor data.

### CROSS-REFERENCE TO RELATED APPLICATION

This application is a Section 111(a) application relating to and claiming the benefit of commonly owned, co-pending U.S. Provisional Patent Application Ser. No. 61/993,473 entitled “VIBRATIONAL ENERGY HARVESTING FOR STRUCTURAL HEALTH INSTRUMENTATION,” filed May 15, 2014, the entirety of which is incorporated herein by reference.

### FIELD OF THE INVENTION

The exemplary embodiments relate to vibrational energy harvesting, and, more specifically, to vibrational energy harvesting in the field of wireless structural health monitoring of bridges.

### BACKGROUND OF THE INVENTION

Current structural health data collection on bridges involves inspectors physically gathering data from sensors (e.g., strain gages, accelerometers, etc.), placed at critical points on the structure. This means that skilled labor must free climb or be hoisted to the bottom of the bridge deck, where such critical points are typically located. The need for manual on-site inspection increases the cost of bridge inspections. As a result, bridges are not inspected frequently enough to catch fatigue crack propagation. For example, current standards require such inspections to be formed every two years. This standard may be insufficient to detect impending fatigue failures of aging infrastructure.

### SUMMARY OF THE INVENTION

In an embodiment, the present invention relates to a system including a vibrational energy harvesting device adapted to receive vibrational energy and convert the vibrational energy to electrical energy; a computing device having an electrical connection to the vibrational energy harvesting device; a sensor having an electrical connection and a data connection to the computing device; and a transmitter having an electrical connection and a data connection to the computing device. When the computing device receives the electrical energy from the vibrational energy harvesting device, the computing device is configured to receive sensor data from the sensor via the data connection between the computing device and the sensor and operate the transmitter to wirelessly transmit the sensor data.

In an embodiment, the vibrational energy harvesting device includes a tube having a first end, a second end opposite the first end, an outer surface, an inside diameter, and a longitudinal axis; a first magnet fixed to the first end of the tube and fixed against rotation within the tube, a second magnet disposed within the tube between the first and second ends of the tube, fixed against rotation within the tube other than about the longitudinal axis, and oriented such that a magnetic force between the first magnet and the second magnet repels the second magnet away from the first magnet, a conductive wire wrapped around the outer surface of the tube such that motion of the second magnet along the longitudinal axis of the tube induces electrical current in the conductive wire, and a storage element electrically coupled to the conductive wire and operative to store the electrical energy carried by the electrical current.

In an embodiment, the storage element includes at least one capacitor. In an embodiment, the at least one capacitor includes a capacitor having a capacitance of 1 farad. In an embodiment, the storage element is configured to store the electrical energy until an electrical potential of the stored electrical energy reaches a first threshold value and, when the stored electrical potential reaches the first threshold value, the storage element is further configured to discharge the stored electrical energy until the electrical potential reaches a second threshold value. In an embodiment, the first threshold value is about 5.2 volts and the second threshold value is about 3.1 volts. In an embodiment, the conductive wire includes copper wire. In an embodiment, the copper wire is wrapped around the outer surface of the tube about 9000 times.

In an embodiment, the transmitter wirelessly transmits the sensor data using one of an 802.15.4 networking protocol and a ZigBee networking protocol. In an embodiment, the system also includes a housing enclosing the vibrational energy harvesting device, the computing device, the sensor, and the transmitter. In an embodiment, the housing is adapted to be affixed to a bridge. In an embodiment, the sensor includes one of an accelerometer, a three-axis accelerometer, and a strain gage.

In an embodiment, the present invention relates to a vibrational energy harvesting device including a tube having a first end, a second end opposite the first end, an outer surface, an inner surface opposite the outer surface, and a longitudinal axis, a first magnet located within the tube, fixed against rotation in the tube, and fixed at the first end of the tube, a second magnet located within the tube, fixed against rotation in the tube other than about the longitudinal axis, free to move along the tube between the first and the second ends, and oriented such that a magnetic force between the first magnet and the second magnet repels the second magnet from the first magnet, and a conductive wire wrapped around the outer surface of the tube such that motion of the second magnet along the longitudinal axis of the tube induces electrical current in the conductive wire.

In an embodiment, the vibrational energy harvesting device also includes a storage element electrically coupled to the conductive wire and operative to store electrical energy carried by the electrical current. In an embodiment, the storage element includes at least one capacitor. In an embodiment, the conductive wire includes copper wire. In an embodiment, the conductive wire is wrapped around the outer surface of the tube about 9000 times.

### BRIEF DESCRIPTION OF THE FIGURES

FIG. 1 is a schematic representation of a system for vibrational energy harvesting for structural health instrumentation (“VEHSHI”) according to an exemplary embodiment.

FIG. 2 is a schematic representation of an exemplary energy harvesting device that is a component of the exemplary VEHSHI system of FIG. 1.

FIG. 3 is a schematic representation of an exemplary structural health monitoring device that is a component of the exemplary VEHSHI system of FIG. 1.

FIG. 4 is a schematic representation of an exemplary wireless transmitting device that is a component of the exemplary VEHSHI system of FIG. 1.

FIG. 5 is an illustration of an embodiment of the VEHSHI system of FIG. 1.

### DETAILED DESCRIPTION OF THE INVENTION

The exemplary embodiments relate to a system for vibrational energy harvesting for structural health instrumentation (“VEHSHI”). As will be described in greater detail hereinafter, the exemplary embodiments may obtain a continuous picture of bridge health by powering sensors and transmitters with electrical energy converted from bridge vibrations. The exemplary embodiments use the energy so obtained to power an accelerometer to provide structural health monitoring for a bridge, and also to power a wireless transmission system to send the raw data measured by the accelerometer to a receiver where the data may be interpreted. The exemplary embodiments may thereby create a self-sufficient, continuous structural health monitoring device powered by traffic induced bridge vibrations.

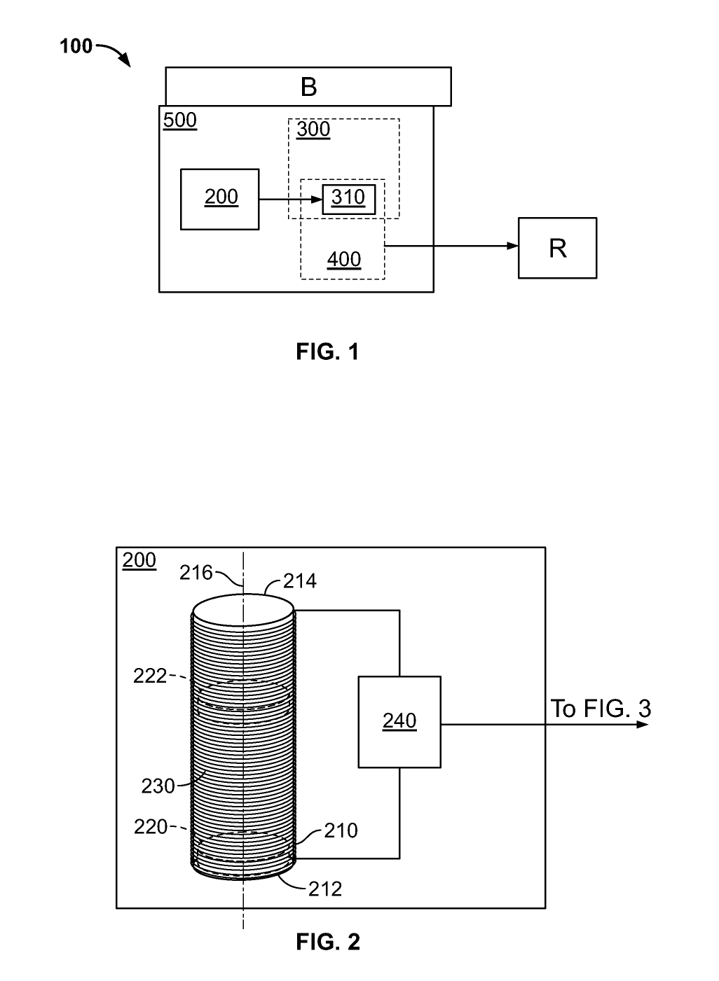

As illustrated in FIG. 1, an exemplary VEHSHI system 100 may be schematically represented by three main components: an energy harvesting device 200, a structural health monitoring device 300, and a wireless transmitting device 400. Specific elements of the energy harvesting device 200, the structural health monitoring device 300, and the wireless transmitting device 400 will be described hereinafter, but those of skill in the art will recognize that other structural elements may be used to perform the same functions without departing from the broader principles embodied by the exemplary VEHSHI system 100.

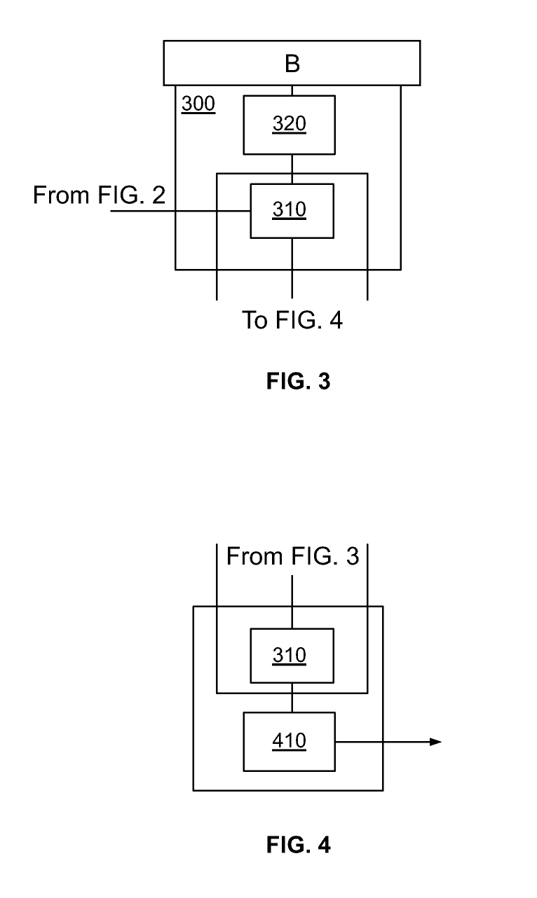

The energy harvesting device 200, illustrated in detail in FIG. 2, includes a tube 210 having a first end 212 and a second end 214 opposite the first end 212. The first end 212 is an end of the tube 210 that will be below the second end 214 when the VEHSHI system 100 is installed. In an embodiment, the tube 210 is oriented such that the first end 212 will be vertically below the second end 214 when the VEHSHI system 100 is installed in a desired orientation. The tube 210 has a longitudinal axis 216 extending longitudinally along the tube 210 in a direction from the first end 212 to the second end 214. The tube 210 encloses two repelling magnets 220, 222 (shown in phantom). It will be known to those of skill in the art that magnets may repel one another when poles of like polarity are placed in proximity to one another, i.e., when a north pole of a first magnet is placed in proximity to a north pole of a second magnet, or when a south pole of a first magnet is placed in proximity to a second magnet. Thus, the magnets 220, 222 may repel one another due to the north pole of the magnet 220 facing the north pole of the magnet 222, or the south pole of the magnet 220 facing the south pole of the magnet 222.

In an embodiment, the tube 210 is a one-inch inner diameter polycarbonate tube. The magnet 220 is fixed at a first end 212 of the tube 210. The magnet 222 is located within the tube 210, between the first end 212 and the second end 214 and above the magnet 220. The magnets 220, 222 are free to rotate about the longitudinal axis 216 of the tube 210, but are otherwise constrained against rotation within the tube 210 in order to retain the poles of the magnets 220, 222 in an orientation such that the magnets 220, 222 generate a repulsive magnetic force with respect to one another. In an embodiment, the magnets 220, 222 are cylindrical and have an outside diameter sized to form a clearance fit with the inside diameter of the tube 210. Because the magnet 220 is at the first end 212 which is vertically at a bottom of the tube 210, the magnet 222 is pulled downward by gravity but pushed upward by the repulsive magnetic force between the magnet 220 and the magnet 222, and, thus, rests above the magnet 220.

A conductive wire 230 is wrapped around the outside of the tube 210. In an embodiment, the wire 230 is a 42 gage enameled copper wire coil and is wrapped about 9000 times around the tube 210. When the energy harvesting device 200 is subject to acceleration, such as may result from vibration of a bridge to which the energy harvesting device 200 is affixed, the magnet 222 moves along the tube 210 toward and away from the magnet 220, and, correspondingly, plunges through the coil 230. The motion of the magnet 222 thereby induces electrical voltage within the coil 230 according to Faraday's Law. The voltage produced in this manner may be quantified by the following expression:

$$V = - N \frac{\partial φ}{\partial t}$$

where:

V=Electromagnetic voltage

N=Number of turns of coil

Φ=Magnetic flux

t=time

An exemplary energy harvesting device 200 arranged as described above may generate about 16 milliwatts of power. Continuing to refer to FIG. 2, the coil 230 is electrically coupled to a storage element 240. The specific structure of the storage element 240 may be selected in order that the storage element 240 is capable of storing and providing sufficient electrical energy to power the structural health monitoring device 300 and the wireless transmitting device 400. In an embodiment, the storage element 240 includes one or more capacitors. In an embodiment, the storage element 240 is configured to store electrical energy from the voltage induced in the coil 230 until the accumulated voltage has reached an upper threshold value of about 5.2 volts, at which point the storage element 240 is configured to discharge energy until its accumulated voltage has reached a lower threshold value of about 3.1 volts. In an embodiment, the storage element 240 includes a commercially produced energy harvesting module including logic enabling such configuration. In an embodiment, the storage element 240 includes an EH301a energy harvesting module manufactured by Advanced Linear Devices, Inc., of Sunnyvale, Calif. In an embodiment, the storage element 240 includes a commercially produced energy harvesting module operating in conjunction with one or more capacitors increasing its overall energy storage capacity. In an embodiment, the storage element 240 includes a 1.0 farad capacitor. An exemplary storage element 240 arranged as above may reach its capacity after about 10 minutes of vibrations.

Referring back to FIG. 1, the energy harvesting device 200, and, more specifically, the storage element 240 thereof, is electrically coupled to the structural health monitoring device 300. Referring now to FIG. 3, the structural health monitoring device 300 includes a computing device 310 that is directly electrically coupled to, and powered by, the storage element 240 of the energy harvesting device 200. The computing device 310 may include an appropriate combination of hardware and software for performing the functions that will be described. In an embodiment, the computing device 310 includes a processor and a flash memory. In an embodiment, the computing device 310 includes a LilyPad Arduino microcontroller manufactured by Arduino, LLC, of Somerville, Mass. The computing device is electrically coupled to a structural monitoring element 320, which may be any type or sensor or arrangement of sensors capable of measuring a structural parameter of interest regarding, for example, a bridge B. In an embodiment, the structural monitoring element 320 includes an accelerometer. In an embodiment, the structural monitoring element 320 includes a three-axis accelerometer. In an embodiment, the three-axis accelerometer is an MMA7361 accelerometer manufactured by Freescale Semiconductor, Inc., of Austin, Tex. In an embodiment, the structural monitoring element 320 includes a strain gage. When the storage element 240 accumulates a suitable charge and begins to discharge energy to the computing device 310, as described above, the computing device 310 executes code to record data measured by structural monitoring element 320. For example, in an embodiment wherein the structural monitoring element 320 includes a three-axis accelerometer, the computing device 310 may record three columns of data, one for each axis.

Referring now to FIG. 4, the computing device 310, described above as an element of the structural health monitoring device 300, is shared by and also an element of the wireless transmitting device 400. The wireless transmitting device 400 also includes a wireless transmitter 410 that is powered and controlled by the computing device 310. The wireless transmitter 410 may be any type of wireless transmitter capable of transmitting the data generated by the structural health monitoring device 300 using the power generated by the energy harvesting device 200. The wireless transmitter 410 may transmit data using any protocol suitable for the data described. In an embodiment, the wireless transmitter 410 transmits data using a personal area networking protocol. In an embodiment, the wireless transmitter 410 transmits data using an IEEE 802.15.4 protocol. In an embodiment, the wireless transmitter 410 transmits data using a ZigBee protocol. In an embodiment, the wireless transmitter 410 is an XBee wireless transmitter manufactured by Digi International of Minnetonka, Minn. After structural monitoring data is recorded by the computing device 310, as described above with reference to the operation of the structural health monitoring device 300, the computing device 310 is also configured to operate the wireless transmitter 410 to transmit the recorded data. An exemplary energy harvesting device 200 as described above may be capable of powering the exemplary structural health monitoring device 300 and the transmitting device 400 to record and send ten transmissions per second for seven seconds at a transmission power sufficient to reach a receiver 50 feet away through multiple walls; it will be apparent to those of skill in the art that a longer range may be achieved if no obstructions are present between the transmitting device 400 and a receiver.

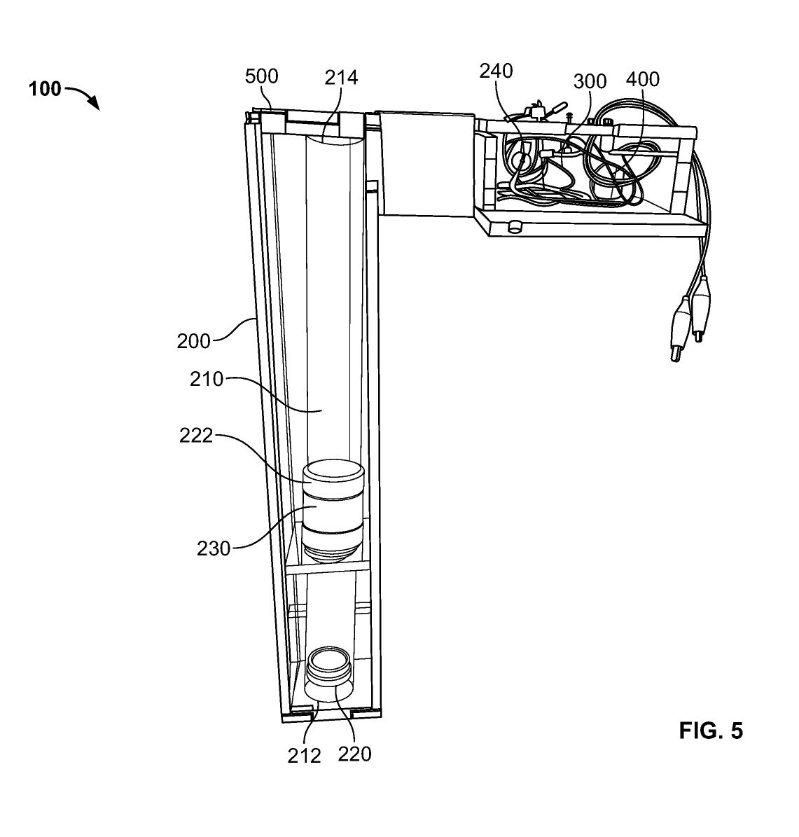

Referring back to FIG. 1, the elements of the VEHSHI system 100 (e.g., the energy harvesting device 200, the structural health monitoring device 300, and the wireless transmitting device 400) are enclosed within a housing 500, which may be weatherproof and capable of being attached to a bridge (B). The housing 500 may be of any shape, size, and material capable of enclosing the elements described above and sheltering them as described. FIG. 5 illustrates an embodiment of a VEHSHI system 100 including a housing 500. In the VEHSHI system 100 of FIG. 5, the housing 500 comprises clear plastic. The housing 500 may be attached to a bridge in an orientation such that the tube 210 is substantially vertical, in order that vibrations may cause the magnet 222 to move within the tube 210 as described above. In an embodiment, the housing 500 may be placed in a hard-to-reach area of a bridge in order to facilitate the recording of measurements about the bridge that would be difficult to manually obtain using prior techniques.

Referring back to FIG. 1, data measured and transmitted by the VEHSHI system 100 may be received by a receiver R. The receiver R may be any apparatus capable of receiving and interpreting the signals transmitted by the VEHSHI system 100. In one embodiment, the receiver R may include a USB receiver coupled to a computing system. The USB receiver may receive the signals, and the computing system may interpret the signals in a standard manner, e.g., in the same manner that manually collected data would be interpreted. The receiver R may be located within line of sight of the VEHSHI system 100; such placement may reduce the energy required for transmission by requiring transmission only through air, rather than through structural elements of a bridge B on which the VEHSHI system 100 is installed. The receiver R may be fixed in an appropriate location or may be placed in an appropriate location periodically. In an embodiment, the receiver R may be placed on top of the bridge deck of a bridge B that the VEHSHI system 100 is instrumenting.

Data obtained using the exemplary VEHSHI system 100 may be analyzed locally at the receiver R, or may be conveyed to another location for analysis, which may be performed using any serial monitoring package known in the art. Monitoring and analysis in this manner may provide a bridge operator with a more continuous picture of the evolution of a bridge's health between the 2-year inspection intervals currently required, and may thereby be alerted when there is a hazardous deviation from an average for any key metrics. The information obtained in this manner may enable the need for repairs to be diagnosed promptly, allowing repairs to be performed locally at the site of a problem, which may cost on the order of $500,000, rather than failing to diagnose a problem until a larger structural failure has occurred, necessitating a bridge replacement that may cost on the order of $25,000,000.

The exemplary embodiments have been described herein with specific reference to harvesting vibrational energy and applying energy so harvested to monitoring bridge structures. However, it will be apparent to those skilled in the art that the same techniques embodied by the exemplary VEHSHI system 100 may be equally applicable to the monitoring of any other type of structure subject to sufficient vibrations to supply the requisite energy, such as surface roadways, railway infrastructure, vehicle structures, building structures, etc. Further, the exemplary VEHSHI system 100 or similar system may apply the energy generated to power utilities on a bridge or roadway, such as street lights or traffic lights.

In addition to structural monitoring, the broader concepts embodied by the exemplary VEHSHI system 100 may also be applicable to the harvesting of vibrational energy for other purposes. In one alternative embodiment, a similar system may be used to harvest vibrational energy from ocean waves, and energy so collected may then be used to power a device that measures tidal elevations. In another alternative embodiment, a system that harvests vibrational energy may be used to harvest energy from human movements. A wearable device could harvest energy while its wearer walks, runs, or moves otherwise. Energy harvested in this manner could then be used to power any number of devices, including to power the charging of a cellular phone, beeper, PDA, or digital camera.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

What is claimed is:

1. A system, comprising:
a vibrational energy harvesting device adapted to receive vibrational energy and convert the vibrational energy to electrical energy;
a computing device having an electrical connection to said vibrational energy harvesting device;
a sensor having an electrical connection and a data connection to said computing device; and
a transmitter having an electrical connection and a data connection to said computing device,
wherein, when said computing device receives the electrical energy from said vibrational energy harvesting device, said computing device is configured to:
receive sensor data from said sensor via said data connection between said computing device and said sensor; and
operate said transmitter to wirelessly transmit said sensor data.

2. The system of claim 1, wherein said vibrational energy harvesting device includes:
a tube having a first end, a second end opposite the first end, an outer surface, an inside diameter, and a longitudinal axis,
a first magnet fixed to said first end of said tube and fixed against rotation within said tube,
a second magnet disposed within said tube between said first and second ends of said tube, fixed against rotation within said tube other than about said longitudinal axis, and oriented such that a magnetic force between said first magnet and said second magnet repels said second magnet away from said first magnet;
a conductive wire wrapped around said outer surface of said tube such that motion of said second magnet along said longitudinal axis of said tube induces electrical current in said conductive wire; and
a storage element electrically coupled to said conductive wire and operative to store the electrical energy carried by said electrical current.

3. The system of claim 2, wherein said storage element includes at least one capacitor.

4. The system of claim 3, wherein said at least one capacitor includes a capacitor having a capacitance of 1 farad.

5. The system of claim 2, wherein said storage element is configured to store the electrical energy until an electrical potential of the stored electrical energy reaches a first threshold value and, when the stored electrical potential reaches said first threshold value, said storage element is further configured to discharge said stored electrical energy until the electrical potential reaches a second threshold value.

6. The system of claim 5, wherein said first threshold value is about 5.2 volts and said second threshold value is about 3.1 volts.

7. The system of claim 2, wherein said conductive wire includes copper wire.

8. The system of claim 7, wherein said copper wire is wrapped around said outer surface of said tube about 9000 times.

9. The system of claim 1, wherein said transmitter wirelessly transmits said sensor data using one of an 802.15.4 networking protocol and a ZigBee networking protocol.

10. The system of claim 1, further comprising:
a housing enclosing said vibrational energy harvesting device, said computing device, said sensor, and said transmitter.

11. The system of claim 10, wherein said housing is adapted to be affixed to a bridge.

12. The system of claim 1, wherein said sensor includes one of an accelerometer, a three-axis accelerometer, and a strain gage.

13. A vibrational energy harvesting device, comprising:
a tube having a first end, a second end opposite the first end, an outer surface, an inner surface opposite the outer surface, and a longitudinal axis;
a first magnet located within said tube, fixed against rotation in said tube, and fixed at said first end of said tube;
a second magnet located within said tube, fixed against rotation in said tube other than about said longitudinal axis, free to move along said tube between said first and said second ends, and oriented such that a magnetic force between said first magnet and said second magnet repels said second magnet from said first magnet; and
a conductive wire wrapped around said outer surface of said tube such that motion of said second magnet along said longitudinal axis of said tube induces electrical current in said conductive wire.

14. The vibrational energy harvesting device of claim 13, further comprising:
a storage element electrically coupled to said conductive wire and operative to store electrical energy carried by said electrical current.

15. The vibrational energy harvesting device of claim 14, wherein said storage element includes at least one capacitor.

16. The vibrational energy harvesting device of claim 13, wherein said conductive wire includes copper wire.

17. The vibrational energy harvesting device of claim 13, wherein said conductive wire is wrapped around said outer surface of said tube about 9000 times.
